(19) United States
(12) Patent Application Publication
(10) Pub. No.: US 2003/0033138 A1
(43) Pub. Date: Feb. 13, 2003

(54) Method for partitioning a data set into frequency vectors for clustering

(76) Inventors: Srinivas Bangalore, Morristown, NJ (US); Giuseppe Riccardi, Hoboken, NJ (US)

Correspondence Address: KENYON & KENYON, 1500 K STREET, N.W., SUITE 700, WASHINGTON, DC, 20005, US

(21) Appl. No.: 10/260,294

(22) Filed: Oct. 1, 2002

Related U.S. Application Data
(63) Continuation-in-part of application No. 09/912,461, filed on Jul. 26, 2001.

(51) Int. Cl. G10L 19/14

(52) U.S. Cl. 704/205

(57) ABSTRACT

A method of partitioning a data set in which certain elements of the data set are first identified as robust discriminator data elements. For the other non-discriminator data elements, an embodiment of the invention counts occurrences of a predetermined relationship between each non-discriminator data element and the identified robust discriminator data elements, and maps the counted occurrences onto vectors a multi-dimensional frequency space. Finally, an embodiment forms the frequency vectors into clusters according to a distance or adjacency metric, where each cluster represents a different contextual class of meaningful attributes. The data set is thereby partitioned into an arbitrary number of clusters according to the discovered relationships between the non-discriminator data elements and the robust discriminator data elements so that all of the non-discriminator data elements located in the same cluster possess similar attributes.

### RELATED APPLICATIONS

This application is a continuation-in-part of U.S. patent application Ser. No. 09/912,461, entitled “Automatic Clustering of Tokens From a Corpus for Grammar Acquisition,” filed on Jul. 26, 2001 (which benefits from the priority of U.S. patent application Ser. No. 09/207,326, now U.S. Pat. No. 6,317,707).

### TECHNICAL FIELD

The present invention relates to the general area of data mining tools, which attempt to find patterns of information stored in large data sets. More specifically, the present invention relates to methods of discovering relationships between elements of a data set through the use of data partitioning techniques.

### BACKGROUND OF THE INVENTION

Data mining is a process of finding patterns within information contained in large data sets. With the success of database systems and their resulting widespread use, the role of the database has expanded from being a reliable data store to the role of a decision support system. This expansion has been manifested in the growth of data warehouses that consolidate transactional and distributed databases.

Examples of applications in which data mining techniques have been used include: fraud detection in banking and telecommunications; customer demographic detection in marketing systems; the analysis of object characteristics in large data sets (e.g., cataloging detected objects in space, discovering atmospheric events in remote sensing data); and diagnosing errors in automated manufacturing systems. The techniques used in data mining are particularly relevant in settings where data is plentiful and where the processes generating the data are poorly understood.

Data mining techniques are fundamentally data reduction and data visualization techniques. As the number of dimensions in a particular data set grows, the number of ways of choosing combinations of elements so as to reduce the dimensionality of the data set increases exponentially. For an analyst exploring various data models, it is generally infeasible to examine exhaustively all possible ways of projecting the dimensions or selecting subsets of the data. Additionally, projecting the data into fewer dimensions may render an easy discrimination problem much more difficult because important distinctions have been eliminated by the projection.

Several methods exist in the art to help analysts find patterns or models which may otherwise remain hidden in a high-dimension data space. For example, various data clustering algorithms exist that partition data elements into groups, called clusters, such that similar data elements fall into the same group. In these data clustering algorithms, similarity between data elements is typically determined by a distance function.

One of the problems of data mining methods in general, and of clustering techniques in particular, is the initial selection of data elements around which clusters will be formed. Several solutions have been proposed. These solutions generally involve the extraction of easily-defined subsets of data elements from the data set. One of the known approaches involves selecting “rows” of data elements from the data set, where the selected data elements satisfy certain statistical or logical conditions. Because rows of data elements are being grouped together, this approach may be described as “horizontal.” Another approach can be characterized as “vertical,” since it finds relationships between particular fields (or columns) of data elements based on specified association rules. These known approaches are limited in their application by a variety of factors, including their inability to mine unstructured data adequately, their reliance on fixed rules or conditions that pertain to specific data sets, their requirement that selected data elements map into a fixed number of clusters, and their relative inability to operate on data sets that grow and/or evolve over time.

Accordingly, there is a need in the art for a data mining system that is able to select initial subsets of data elements around which arbitrary numbers of clusters may be formed dynamically, and which is adapted to operate on unstructured data sets.

### SUMMARY OF THE INVENTION

Embodiments of the present invention are directed to a method of partitioning a data set in which certain elements within the data set are first identified as robust discriminators. For the remaining non-discriminator data elements, an embodiment of the invention counts occurrences of a predetermined relationship between each non-discriminator data element and the identified robust discriminators, and maps the counted occurrences onto vectors a multi-dimensional frequency space. Finally, an embodiment forms the frequency vectors into clusters according to a distance or adjacency metric, where each cluster represents a different contextual class of meaningful attributes. Embodiments of the invention thereby partition a data set into an arbitrary number of clusters according to discovered relationships between non-discriminator data elements and the robust discriminators, such that all non-discriminator data elements in the same cluster possess similar attributes.

### BRIEF DESCRIPTION OF THE DRAWINGS

FIG. 1 is a high-level block diagram of a computing system incorporating a data mining application in accordance with an embodiment of the present invention.

FIG. 2 is a flow diagram of a method of the present invention, according to an embodiment.

FIG. 3 illustrates a mapping of frequency vectors that may be obtained during an operation of an embodiment of the present invention.

FIG. 4 illustrates an exemplary cluster tree formed by application of an embodiment of the present invention.

### DETAILED DESCRIPTION

Embodiments of the present invention will be described in reference to the accompanying drawings, wherein like parts are designated by like reference numerals throughout, and wherein the leftmost digit of each reference number refers to the drawing number of the figure in which the referenced part first appears.

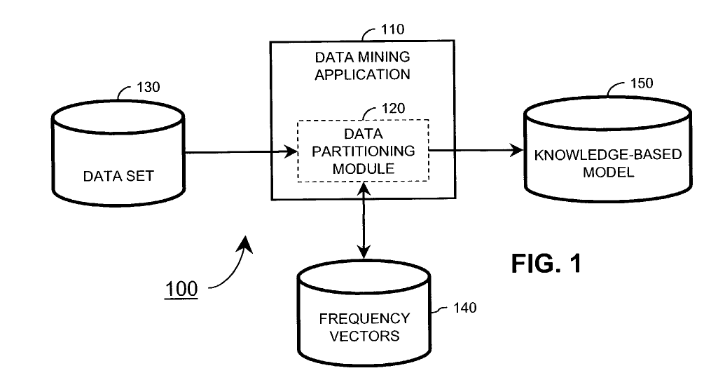

FIG. 1 is a high-level block diagram of a computer system 100 incorporating a data mining application 110 in accordance with an embodiment of the present invention. Data mining application 110 may include a data partitioning module 120 for interacting with a data set 130 in order to discover and identify relationships that may be present between elements of data set 130. When data partitioning module 120 operates on data set 130, data partitioning module 120 may identify certain elements of data set 130 as “robust discriminators” and other elements as “non-discriminator elements.” After selecting each of the non-discriminator elements, data partitioning module 120 may create a set of multi-dimensional frequency vectors 140, where each individual frequency vector measures the number of times a non-discriminator element is associated with each of the identified robust discriminators. Using the generated frequency vectors 140, data partitioning module 120 may then cluster the frequency vectors 140 to form a knowledge-based model 150 based on the clusters.

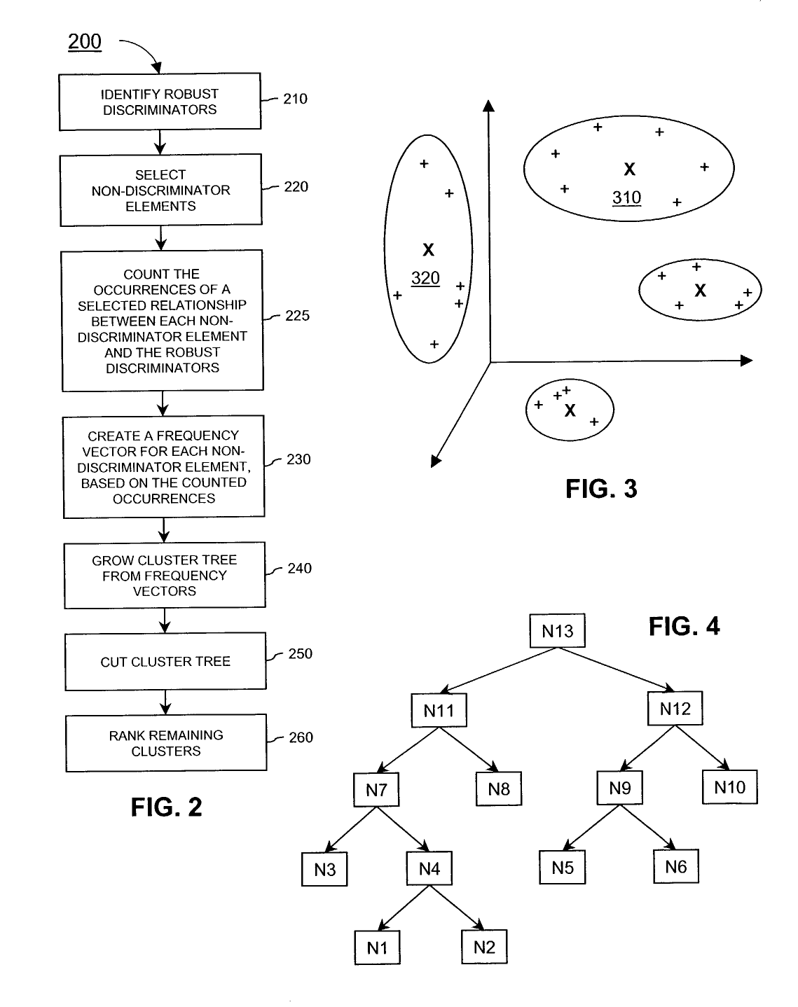

FIG. 2 is a flow diagram of a method 200 of the present invention, according to an embodiment. The method 200 operates upon a data set. For clarity of information, the term “data set” as used herein is a general term referring to a data file or a collection of interrelated data. The term may also comprise a traditional database, which incorporates a set of related files that are created and managed by a database management system. Data sets may contain virtually any form of structured or unstructured information, including text, numbers, images, sound, and video, as well as instructions for processing data and for controlling the operational characteristics of complex automation systems. Each of the elements in a data set may be represented by a finite set of properties, which may be expressed as attribute-value pairs.

Additionally, the term “data element” as used herein refers to any unit of data defined for a data set. For example, a data element may be the definition of an account number, name, address, or city. Data elements are usually characterized operationally by size and/or type. Specific sets of values or ranges of values may also be a part of the definition. Traditionally, the term “data element” is used to describe a logical unit of data; the term “data field” refers to actual storage units; and the term “data item” represents an individual instance of a data element. As used herein, however, all three terms (data element, data field, and data item) are used interchangeably.

Continuing to refer to FIG. 2, the method 200 first identifies robust discriminators within the data set (210). A robust discriminator may be a data element that exhibits a particular quality, such as a high frequency of occurrence in the data set. In this situation, the robust discriminator may be termed a robust discriminator element. Other qualities that may identify an element as a robust discriminator include: the size of the element, the spatial or temporal distance of the robust discriminator from other elements, and membership of the robust discriminator element in one or more well-defined sets. For example, in a data set composed primarily of words of text, robust discriminator elements may be selected from the words or phrases that occur with the highest frequency. As another example, in a data set that records customer interaction with Internet web pages, a robust discriminator element may be a customer's zip code, the price of a purchased item, the time a specific web page was accessed, the time of a web-based purchase, the value of a purchased item, the number of queries initiated, or the subject matter of material accessed at the web site. In yet another example involving voice-mail messages, a robust discriminator element may be the frequency of phonemes identified in the message, the telephone number of the caller, and the sequence of digits keyed by the caller in response to automated voice prompts.

Still referring to FIG. 2, the method 200 may also use particular relations between data elements as robust discriminators, rather than selecting particular data elements themselves (210). Thus, the value of a relationship between collections of data elements may form the basis for identifying robust discriminators. These particular robust discriminators, which are based on the value of a predetermined relation between data elements, may be characterized as derived robust discriminators, since they are derived from the application of a relational operator upon sets or subsets of data elements. As an example, in a data set that records customer interaction with Internet web pages, a derived robust discriminator may be the relationship between a customer's zip code and the price of a purchased item. Another example of a derived robust discriminator may be a discovered correlation between a customer's previously-purchased items and specific problem reports pertaining to those items.

After robust discriminators have been identified (210), the method 200 considers data elements which have not been identified as robust discriminators to be non-discriminator elements (220). For each of the non-discriminator elements, the method 200 determines the number of times a particular relationship exists between that non-discriminator element and every robust discriminator (225). For example, the method 200 may determine how many times and in which positions a given input word of text (a non-discriminator element) is adjacent to a high-frequency context word (a robust discriminator).

Based upon the discovered frequencies, an N dimensional frequency vector may be built for each non-discriminator element (230). The number of dimensions N of the frequency vector is a multiple of the total number of robust discriminators, the total number of elements in the data set, and the total number of relations identified by the method 200. Each component of the frequency vector represents a relational link that exists between a data set element and a robust discriminator. Thus, each data set element maps to an N dimensional frequency space. A representative frequency space is shown in FIG. 3, where N=3.

The method 200 builds an arbitrary number of clusters of data elements (240) from the generated frequency vectors. According to the principles of the present invention, data elements having the same relative significance will possess similar vectors in the frequency space. Thus, it is expected that city names, for example, will exhibit frequency characteristics that are similar to each other but different from other data elements having a different significance. For this reason, the city names will be included in the same cluster (say, cluster 310, FIG. 3). So, too, with colors. They will be included in another cluster (say, cluster 320, FIG. 3). In general, the method 200 ensures that whenever data elements exhibit similar frequency vectors, they will be included within the same cluster.

As is known, a cluster may be represented in an N-dimensional frequency space by a centroid coordinate and a radius indicating the volume of the cluster. The radius indicates the “compactness” of the elements within a cluster. Where a cluster has a small radius, the data elements within the cluster exhibit a very close relationship to each other in the frequency space. A larger radius indicates less similarities between elements in the frequency space.

The similarity between two data elements may be measured using the Manhattan distance metric between their feature vectors. Manhattan distance is based on the sum of the absolute value of the differences among the vector's coordinates. Alternatively, Euclidean and maximum metrics may be used to measure distances. Experimentally, the Manhattan distance metric has been shown to provide better results than the Euclidean or maximum distance metrics in creating clusters.

Step 240 may be applied recursively to grow clusters from clusters. That is, when two or more clusters are located close to one another in the N dimensional space, the method 200 may enclose the neighboring clusters in a single cluster having its own unique centroid and radius. The method 200 determines a distance between two clusters by determining the distance between their individual centroids using one of the metrics discussed above with respect to the vectors of data elements. Thus, the Manhattan, Euclidean and maximum distance metrics may be used recursively to grow clusters from groups of clusters, as well as to form the initial clusters from data elements.

According to method 200, a hierarchical “cluster tree” is grown, which represents a hierarchy of clusters. An exemplary cluster tree is shown in FIG. 4. At one terminal node in the cluster tree (e.g., N1 of FIG. 4), the centroid and radius of a first cluster is stored. Branches of the tree extend from the terminal node (or leaf node) to other internal nodes of the tree where the centroids and radii of subsumed clusters are stored. Thus, each node of the tree structure maintains the centroid and radius of every cluster built. The method 200 continues to grow clusters until a single, all-encompassing cluster encloses all child clusters and data elements (240). This cluster is termed the “root cluster” because it is stored as the root node of the cluster tree.

As will be appreciated, the root cluster N13 (FIG. 4) will have a radius large enough to enclose all clusters and data elements. The root cluster, therefore, will possess little contextual significance. By contrast, the “leaf clusters”—those clusters provided at the ends of branches in the cluster tree—will possess very strong contextual significance.

After the clusters have been formed, the method 200 cuts the cluster tree along a predetermined line in the tree structure (250). The cutting line separates large clusters from smaller clusters. The large clusters are discarded. What remains are the smaller clusters—those with greater lexical significance.

The cutting line determines the number of clusters that will remain. One may use the median of the distances between clusters merged at the successive stages as a basis for the cutting line and prune the cluster tree at the point where cluster distances exceed this median value. Clusters are defined by the structure of the tree above the cutoff point.

Finally, the method 200 ranks the remaining clusters (260). The contextual significance of a particular cluster is measured by its compactness value. The compactness value of a cluster simply may be its radius or an average distance of the members of the cluster from the centroid of the cluster. Thus, the tighter clusters exhibiting greater significance will occur first in the ranked list of clusters and those exhibiting lesser significance will occur later in the list. The list of clusters obtained from the method 200 is a knowledge-based model of the data set (260).

The method 200 is general in that it can be used to cluster elements of a data set at any contextual level. For example, it may be applied to words and/or phrases of words. Other lexical granularities (syllables, phonemes) also may be used.

Adjacency of words is but one relationship to which the method 200 may be applied to recognize from a data set. More generally, however, the method 200 may be used to recognize other predetermined relationships among elements of a data set. For example, the method 200 can be configured to recognize data elements that appear together in the same sentences or words that appear within predetermined positional relationships with punctuation. Taken even further, the method 200 may be configured to recognize predetermined grammatical constructs of language, such as subjects and/or objects of verbs. Each of these latter examples of relationships may require that the method be pre-configured to recognize the grammatical constructs.

The method 200 may also be applied to recognize patterns and relationships between the recorded activities of users who interact with an automated response system, such as a automated telephone system for handling customer service calls. In this example, the clusters obtained from method 200 might correspond to a knowledge-based model of related customer problems or requests, organized by subject matter or organized according to time of occurrence. Additionally the clusters obtained from method 200 may also correspond to a knowledge-based model of customer demographic information.

The method 200 may be further configured to operate on a recorded log of user interactions with an Internet web page, where the web page may provide the ability for a user to perform query operations or to navigate through various displays of information, or the web page may provide numerous options to browse, search, locate, and/or purchase any number of offered products. In this example, the clusters obtained from method 200 may correspond to a knowledge-based model of customer demographic information or marketing information, or may alternatively correspond to a knowledge-based model of related customer problems.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method of partitioning a data set, comprising:
identifying a plurality of robust discriminators within the data set;
counting occurrences of a predetermined relationship between each non-discriminator data element in the data set and each of the identified robust discriminators;
creating a frequency vector for each non-discriminator element based on the counted occurrences;
clustering the frequency vectors into clusters; and
forming a knowledge-based model of the data set based on the clusters.

2. The method of claim 1, wherein the plurality of robust discriminators includes a robust discriminator element.

3. The method of claim 2, wherein the robust discriminator element is selected based on a frequency of occurrence in the data set.

4. The method of claim 2, wherein the robust discriminator element is selected based on size.

5. The method of claim 2, wherein the robust discriminator element is selected based on a spatial distance of the robust discriminator element to other data elements in the data set.

6. The method of claim 2, wherein the robust discriminator element is selected based on a temporal distance of the robust discriminator element to other data elements in the data set.

7. The method of claim 2, wherein the robust discriminator element is selected based on a membership of the robust discriminator element in at least one well-defined set.

8. The method of claim 1, wherein the plurality of robust discriminators includes a derived robust discriminator.

9. The method of claim 8, wherein the derived robust discriminator is selected based on a relationship between a first data element and a second data element.

10. The method of claim 1, wherein the predetermined relationship is a measure of adjacency.

11. The method of claim 1, wherein the clustering is performed based on Euclidean distances between the frequency vectors.

12. The method of claim 1, wherein the clustering is performed based on Manhattan distances between the frequency vectors.

13. The method of claim 1, wherein the clustering is performed based on maximum distance metrics between the frequency vectors.

14. The method of claim 1, wherein the frequency vectors are multi-dimensional vectors, the number of dimensions being determined by a number of robust discriminators and a number of predetermined relationships of the non-discriminator elements to the robust discriminators.

15. A method of extracting user profile information from a recorded log of user interactions with an automated response system, comprising:
selecting a discriminator within the recorded log;
counting occurrences of a predetermined relationship between each non-discriminator data element in the recorded log and the selected discriminator;
generating a frequency vector for each non-discriminator data element based on the counted occurrences;
clustering the frequency vectors into clusters, based on a distance measure between each of the frequency vectors; and
forming a knowledge-based model of the recorded log based on the clusters.

16. The method of claim 15, wherein the discriminator is a data element selected based a frequency of occurrence of similar data elements in the recorded log.

17. The method of claim 15, wherein the discriminator is a data element selected based on a spatial distance of the discriminator to other data elements in the recorded log.

18. The method of claim 15, wherein the discriminator is a data element selected based on a temporal distance of the discriminator to other data elements in the recorded log.

19. The method of claim 15, wherein the discriminator is a data element selected based on a membership of the discriminator in at least one well-defined set.

20. The method of claim 15, wherein the discriminator is a relationship between a first data element and a second data element in the recorded log.

21. The method of claim 15, wherein the automated response system is an automated telephone system for handling customer service calls and the knowledge-based model corresponds to a model of related customer problems.

22. The method of claim 15, wherein the automated response system is an Internet web page for interacting with an on-line user, and the knowledge-based model corresponds to a model of user demographic information.

23. A machine-readable medium having stored thereon a plurality of executable instructions, the plurality of instructions comprising instructions to:
select a discriminator from a data set, based on a predetermined discriminator element selection criteria;
count occurrences of a predetermined relationship between each non-discriminator element in the data set and the selected discriminator;
generate a frequency vector for each non-discriminator element based on the counted occurrences;
cluster the frequency vectors into clusters; and
form a knowledge-based model of the data set based on the clusters.

24. The method of claim 23, wherein the predetermined discriminator element selection criteria is frequency of occurrence in the data set.

25. The method of claim 23, wherein the predetermined relationship is a measure of adjacency.

26. The method of claim 23, wherein the clustering step is performed based on a measure of the distance between the frequency vectors.
